(19) United States
(12) Patent Application Publication
(10) Pub. No.: US 2009/0102473 A1
(43) Pub. Date: Apr. 23, 2009

(54) EDDY CURRENT TESTING METHOD AND EDDY CURRENT TESTING APPARATUS

(76) Inventors: Soshi NARISHIGE, Hitachi (JP); Akira Nishimizu, Tokai (JP); Masahiro Koike, Hitachi (JP); Yoshiharu Abe, Hitachi (JP); Yuichi Narumi, Hitachiohta (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/255,196

(22) Filed: Oct. 21, 2008

(30) Foreign Application Priority Data
Oct. 22, 2007 (JP) 2007-273823
Feb. 21, 2008 (JP) 2008-040265

(51) Int. Cl. G01N 27/90

(52) U.S. Cl. 324/240

(57) ABSTRACT

The present invention provides an eddy current testing method and an eddy current testing apparatus that can reduce detection noise to increase the SN ratio thus improving the defect detection accuracy.

An eddy current testing sensor includes a pair of excitation coils and a detection coil disposed therebetween. For example, a voltage regulator applies voltages having different amplitudes to the pair of excitation coils so as to reduce detection noise caused by a deformed portion of a heat exchanger tube and a tube plate in a detection signal of the detection coil. Alternatively, for example, an eddy current testing detector applies a first excitation frequency f1, at which tube material noise is reduced to negligible an amplitude, and a second excitation frequency f2, which is higher than the first excitation frequency f1, to the eddy current testing sensor. The phase and gain of a measurement waveform with the second excitation frequency f2 are adjusted and then a differential waveform of the first and second excitation frequencies f1 and f2 is obtained based on an induction voltage detected by the detection coil so as to cancel out tube expansion noise.

### BACKGROUND OF THE INVENTION

1. Field of the Invention

The present invention relates to an eddy current testing (ECT) method and an eddy current testing apparatus. More particularly, the present invention relates to an eddy current testing method and an eddy current testing apparatus suitably used for eddy current testing of a tube expansion of heat exchanger tubes of a heat exchanger of a power plant.

2. Description of the Related Art

For example, a heat exchanger tube of a heat exchanger installed in a clean up water system of a nuclear plant is subjected to periodical maintenance and inspection in order to check whether a crack or other defect has occurred. The heat exchanger tube of the heat exchanger is formed, for example, in U shape. Both ends of the heat exchanger tube are inserted into penetration holes of a tube sheet (magnetic material). For details, as shown in FIG. 6, a heat exchanger tube 1 is pressed from the inside so as to expand the tube diameter to be fixed to the tube sheet. The outer surface of the tube expansion 1a is closely in contact with the inner circumferential surface of a penetration hole 2a of a tube sheet 2 to fix the heat exchanger tube 1. Since thermal stress accompanying temperature change acts on the heat exchanger tube 1, a circumferential crack E on the outer surface side, shown by a dotted line, may be caused in an area of an unexpanded tube 1b in the vicinity of a deformed portion 1c (a portion between the tube expansion 1a and the unexpanded tube 1b). Therefore, it is necessary to detect whether or not the circumferential crack E is present in maintenance and inspection of the heat exchanger tube 1.

A method for inspecting the heat exchanger tube 1 may be an eddy current testing method using an eddy current testing sensor which has excitation coils and detection coils. This eddy current testing method performs the steps of inducing an eddy current in the heat exchanger tube 1 using the excitation coil; detecting a change of the eddy current due to a defect of the heat exchanger tube 1 or the like using the detection coil, and determining whether or not a defect is present. However, in the vicinity of the area where the circumferential crack E in the unexpanded tube 1b of the heat exchanger tube 1 is likely to occur, the deformed portion 1c of the heat exchanger tube 1 and the tube sheet 2 exist. Therefore, a change of an eddy current due to the deformed portion 1c of the heat exchanger tube 1 and the tube sheet 2 is detected as noise. This is a reason why detection of the circumferential crack E has been difficult.

The inventors of the present invention advocate an eddy current testing sensor having a pair of excitation coils 3A and 3B and a detection coil 4 disposed therebetween as shown in FIGS. 7A and 7B (FIG. 7A shows a case where the circumferential crack E has not occurred while FIG. 7B shows a case where the circumferential crack E has occurred) (disclosed in, for example, “Development of an ECT Sensor for Inspection near Tube Expansion of Heat Exchanger Tubes”, Collected Summaries of Autumn Convention Lectures 2006, The Japanese Society for Non-Destructive Inspection, Soushi NARUSHIGE, et al., p187-188).

The excitation coils 3A and 3B are disposed such that each of their axial directions becomes approximately perpendicular to the inspection surface (inner circumferential surface) of the heat exchanger tube 1, being spaced from each other in the circumferential direction of the heat exchanger tube 1, to produce excitation current flows mutually in opposite directions in both excitation coils. Then, eddy currents due to the excitation coils 3A and 3B are superimposed in an area between the excitation coils 3A and 3B resulting in an increase in an axial eddy current of the heat exchanger tube 1 (horizontal direction in FIGS. 7A and 7B).

The detection coil 4 is disposed such that its axial direction agrees with the axial direction of the heat exchanger tube 1 so as to detect a change of the circumferential eddy current component of the heat exchanger tube 1. This makes it possible to detect the circumferential crack E while reducing detection noise caused by the deformed portion 1c of the heat exchanger tube 1 and the tube sheet 2. In more detail, the deformed portion 1c of the heat exchanger tube 1 is formed almost uniformly over the entire circumference. Therefore, as shown by the arrows of FIG. 7A, the axial eddy current of the heat exchanger tube 1 due to the excitation coils 3A and 3B bypasses in two different circumferential directions by the deformed portion 1c of the heat exchanger tube 1. For example, voltages applied to the excitation coils 3A and 3B have the same amplitude (in other words, excitation currents have the same amplitude) so that eddy currents due to the excitation coils 3A and 3B have the same amplitude, and the detection coil 4 is disposed on an symmetry axis L between the excitation coils 3A and 3B, thus balancing out the above-mentioned bypass currents in two different circumferential directions at a detection position of the detection coil 4, and reducing detection noise caused by the deformed portion 1c of the heat exchanger tube 1. In the same way, detection noise caused by the tube sheet 2 existing over the entire outer circumferential surface of the heat exchanger tube 1. On the other hand, the circumferential crack E of the heat exchanger tube 1 locally occurs in its circumferential direction. Therefore, as shown by the arrow of the FIG. 7B, the axial eddy current of the heat exchanger tube 1 due to the excitation coils 3A and 3B bypasses being biased toward either of the two different circumferential directions because of the circumferential crack E. Since the detection coil 4 detects the biased bypass current, it becomes possible to detect whether or not the circumferential crack E is present. In this case, a detection signal from the detection coil 4 contains a signal (S) by the circumferential crack E and noise (N) by the deformed portion 1c of the heat exchanger tube 1 and the tube sheet 2; however, the noise (N) has been reduced as mentioned above.

### SUMMARY OF THE INVENTION

The above-mentioned conventional technique has the following problems.

With the above-mentioned conventional technique, voltages applied to the excitation coils 3A and 3B have the same amplitude (in other words, excitation currents have the sample amplitude), and the detection coil 4 is disposed on the symmetry axis L between the excitation coils 3A and 3B, thus balancing out the bypass currents in two different circumferential directions at the detection position of the detection coil 4 and reducing detection noise caused by the deformed portion 1c of the heat exchanger tube 1 and the tube sheet 2. However, since there is a limit in the positional accuracy of the detection coil 4 for a reason of manufacture, the bypass currents in different circumferential directions slightly become off-balance at the detection position of the detection coil 4, resulting in a very small amount of detection noise. Even with a high positional accuracy of the detection coil 4, if the distance (liftoff) between the excitation coil 3A and the inspection surface of the heat exchanger tube 1 differs from the distance between the excitation coil 3B and the inspection surface, the magnitude of the eddy current by the excitation coil 3A will differ from the magnitude of the eddy current by the excitation coil 3B, and the bypass currents in different circumferential directions slightly become off-balance at the detection position of the detection coil 4, resulting in a very small amount of detection noise. Therefore, there has been a room for the reduction of detection noise, that is, the improvement in the SN ratio.

An object of the present invention is to provide an eddy current testing method and an eddy current testing apparatus that can reduce detection noise to increase the SN ratio thus improving the defect detection accuracy.

In order to attain the above-mentioned object, the present invention provides an eddy current testing apparatus which includes an eddy current testing sensor comprising: a pair of excitation coils disposed such that each of their axial directions becomes approximately perpendicular to the inspection surface of a subject, being spaced from each other in the coil radial direction, to induce an eddy current in the subject; and a detection coil disposed between the pair of excitation coils so that its axial direction becomes approximately in parallel with the inspection surface of the subject and approximately perpendicular to a straight line connecting the centers of the excitation coils to detect a change of the eddy current induced in the subject; wherein the eddy current testing apparatus includes excitation voltage control means for applying voltages having different amplitudes to the pair of excitation coils so as to reduce detection noise of the detection coil.

In accordance with the present invention, detection noise can be reduced to increase the SN ratio thus improving the defect detection accuracy.

### BRIEF DESCRIPTION OF THE DRAWINGS

FIG. 1 is a diagram showing an eddy current testing sensor constituting an embodiment of an eddy current testing apparatus according to a first aspect of the present invention, together with a cross-sectional structure of a heat exchanger tube under inspection.

FIG. 2A is a radial sectional view showing the structure of the eddy current testing sensor constituting the embodiment of the eddy current testing apparatus according to the first aspect of the present invention.

FIG. 2B is a fragmentally enlarged view showing disposing directions of excitation coils and a detection coil in the eddy current testing sensor constituting the embodiment of the eddy current testing apparatus according to the first aspect of the present invention.

FIG. 3 is a block diagram showing the overall configuration of the embodiment of the eddy current testing apparatus according to the first aspect of the present invention.

FIG. 4 is a block diagram showing detailed functions of a voltage regulator constituting the embodiment of the eddy current testing apparatus according to the first aspect of the present invention.

FIG. 5A shows a calculation model explaining the effects of the embodiment of the eddy current testing apparatus according to the first aspect of the present invention.

FIG. 5B shows a calculation result (detection data) explaining the effects of the embodiment of the eddy current testing apparatus according to the first aspect of the present invention.

FIG. 6 is a diagram showing the cross-sectional structure of the heat exchanger tube under inspection according to a conventional technique.

FIG. 7A is a diagram showing the configuration and arrangement of an eddy current testing sensor according to the conventional technique.

FIG. 7B is a diagram showing the configuration and arrangement of the eddy current testing sensor according to the conventional technique.

FIG. 8 is a block diagram showing the configuration of an eddy current testing system using an eddy current testing apparatus according to an embodiment of a second aspect of the present invention.

FIG. 9 is a plane view showing the configuration of the eddy current testing sensor used for the eddy current testing apparatus according to the embodiment of the second aspect of the present invention.

FIG. 10 is a three-plane view showing the configuration of excitation coils of the eddy current testing sensor used for the eddy current testing apparatus according to the embodiment of the second aspect of the present invention.

FIG. 11 is a three-plane view showing the configuration of detection coil of the eddy current testing sensor used for the eddy current testing apparatus according to the embodiment of the second aspect of the present invention.

FIG. 12 is a diagram explaining a signal and noise observed during inspection of a tube expansion of the heat exchanger tube by the eddy current testing apparatus according to the embodiment of the second aspect of the present invention.

FIG. 13 is a diagram explaining the signal and noise observed during inspection of the tube expansion of the heat exchanger tube by the eddy current testing apparatus according to the embodiment of the second aspect of the present invention.

FIG. 14 is a block diagram explaining internal processing of an eddy current testing detector of the eddy current testing apparatus according to the embodiment of the second aspect of the present invention.

FIG. 15 is a cross-sectional perspective view showing the structure of a simulation test piece used for a test of the eddy current testing apparatus according to the embodiment of the second aspect of the present invention.

FIG. 16 is a diagram explaining a measurement result by a conventional eddy current testing apparatus.

FIG. 17 is a diagram explaining a measurement result by the eddy current testing apparatus according to the embodiment of the second aspect of the present invention.

### DETAILED DESCRIPTION OF THE PREFERRED EMBODIMENTS

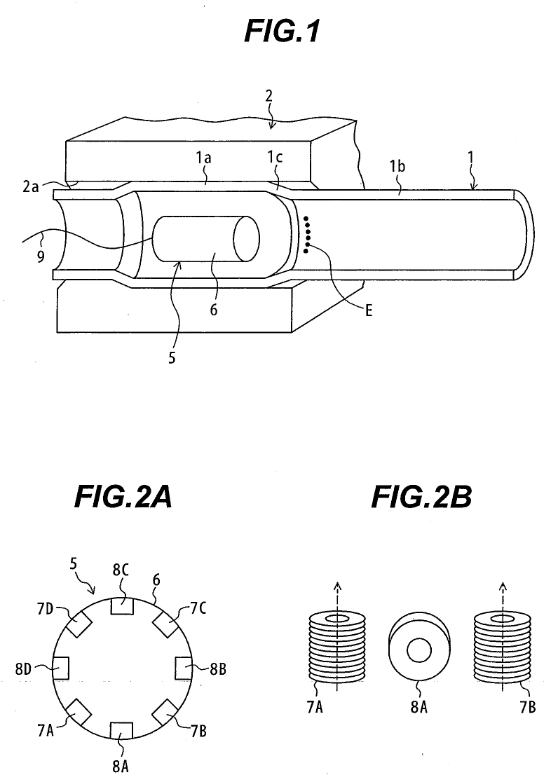

An embodiment of a first aspect of the present invention will be explained below with reference to FIGS. 1 to 5. The present embodiment is intended for inspection of the heat exchanger tube 1 of the above-mentioned heat exchanger. The same symbols are assigned to elements equivalent to those mentioned above, and similar explanations will not be duplicated.

FIG. 1 is a diagram showing an eddy current testing sensor according to the present embodiment, together with the cross-sectional structure of the heat exchanger tube 1.

FIG. 2A is a sectional view showing the circular structure of the eddy current testing sensor, and FIG. 2B is a fragmentally enlarged view showing the disposing directions of excitation coils and a detection coil of FIG. 2A.

Referring to FIGS. 1, 2A, and 2B, an eddy current testing sensor 5 includes a cylindrical main unit case 6 that can be inserted into the heat exchanger tube 1, four excitation coils 7A to 7D circumferentially disposed at equal intervals on the main unit case 6, and four detection coils 8A to 8D each disposed between any two of the excitation coils 7A to 7D. Specifically, the eddy current testing sensor 5 includes a combination of the excitation coils 7A and 7B and the detection coil 8A (first channel), a combination of the excitation coils 7B and 7C and the detection coil 8B (second channel), a combination of the excitation coils 7C and 7D and the detection coil 8C (third channel), and a combination of the excitation coils 7D and 7A and the detection coil 8D (fourth channel).

The excitation coils 7A to 7D are disposed such that each of their axial directions (vertical direction in FIG. 2B) becomes approximately perpendicular to the inspection surface (inner circumferential surface) of the heat exchanger tube 1. Excitation currents in opposite directions are sent to adjacent excitation coils of the excitation coils 7A to 7D. The eddy currents by the excitation coils are superimposed in each channel area resulting in an increase in axial eddy currents of the heat exchanger tube 1.

The detection coils 8A to 8D are disposed such that each of their axial directions (direction perpendicular to the paper in FIG. 2B) agrees with the axial direction of the heat exchanger tube 1 (in other words, each of their axial directions becomes approximately in parallel with the inspection surface of the heat exchanger tube 1 and approximately perpendicular to a straight line connecting the centers of the excitation coils in each channel) to detect a change of the circumferential eddy current component of the heat exchanger tube 1. In this way, a circumferential crack E is detected while reducing detection noise caused by the deformed portion 1c of the heat exchanger tube 1 and the tube sheet 2.

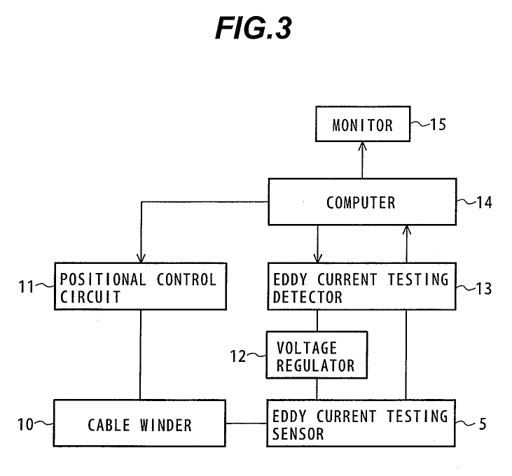

An eddy current testing apparatus having the above-mentioned eddy current testing sensor 5 will be explained below with reference to FIG. 3. FIG. 3 is a block diagram showing the configuration of an eddy current testing apparatus according to the present embodiment.

Referring to FIG. 3, the eddy current testing apparatus comprises: the eddy current testing sensor 5; a cable winder 10 for winding or unwinding a cable (lead wire) 9 connected to the eddy current testing sensor 5; a positional control circuit 11 for controlling the amount of reel-out of the cable 9 of the cable winder 10; an eddy current testing detector 13 for applying voltages to the excitation coils 7A to 7D of the eddy current testing sensor 5 through a voltage regulator 12 and inputting detection signals (induced voltage signals) from the detection coils 8A to 8D of the eddy current testing sensor 5; a computer 14 connected to the positional control circuit 11 and the eddy current testing detector 13; and a monitor 15 connected to the computer 14.

The computer 14 stores preset setup information and setup information set according to operator's input in a storage device (not shown). The computer 14 outputs setup information including the movement speed and displacement of the eddy current testing sensor 5 to the positional control circuit 11. The positional control circuit 11 drives and controls the cable winder 10 based on the setup information to move the eddy current testing sensor 5 in the axial direction of the heat exchanger tube 1. Further, the computer 14 outputs setup information including, for example, the frequency and amplitude of the excitation voltage to the eddy current testing detector 13. The eddy current testing detector 13 controls voltages based on the setup information (detailed control of voltage amplitude will be mentioned later), and applies the voltages to the excitation coils 7A to 7D of the eddy current testing sensor 5. Further, the computer 14 performs the steps of: inputting detection signals from the detection coils 8A to 8D of the eddy current testing sensor 5 through the eddy current testing detector 13; performing predetermined arithmetic processing of the detection signals; creating detection data (waveform data) associated with detection positions of the detection coils 8A to 8D; and displaying the detection data, etc. on the monitor 15.

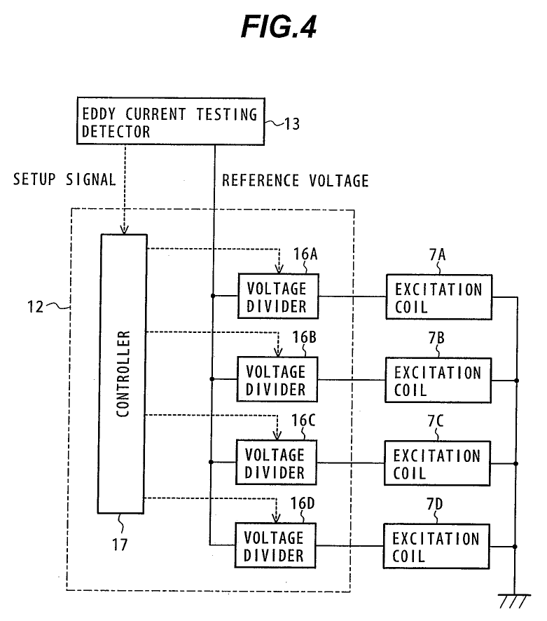

The present embodiment is characterized mainly in that the computer 14 enables input and setup of amplitudes of voltages to be applied to the excitation coils 7A to 7D. A setup signal of the eddy current testing detector 13 associated with the setup information is output to the voltage regulator 12. The voltage regulator 12 controls the amplitudes of voltages applied to the excitation coils 7A to 7D in relation to the setup signal. Detailed functions of the voltage regulator 12 are explained below with reference to FIG. 4. FIG. 4 is a block diagram showing the detailed functions of the voltage regulator.

Referring to FIG. 4, the voltage regulator 12 connects the excitation coils 7A to 7D in parallel. The voltage regulator 12 includes voltage dividers 16A to 16D, connected in series respectively with the excitation coils 7A to 7D, for controlling amplitudes of voltages applied to the excitation coils 7A to 7D (power amplifiers may be used instead of these voltage dividers), and a controller 17 (CPU or the like) for controlling the voltage dividers 16A to 16D based on the setup signal from the eddy current testing detector 13.

The operation of the eddy current testing apparatus of the present embodiment is explained below.

First, a heat exchanger tube without a circumferential crack (not shown) is prepared for a simulation test, and the eddy current testing sensor 5 is disposed at an inspection start position in the heat exchanger tube. Then, the operator inputs and sets a first voltage pattern having different amplitudes of voltages applied to the excitation coils 7A to 7D of the eddy current testing sensor 5 through the computer 14. Then, when the operator inputs an inspection start command through the computer 14, the cable winder 10 operates to move the eddy current testing sensor 5 in the axial direction of the heat exchanger tube. At the same time, the excitation coils 7A to 7D of the eddy current testing sensor 5 are excited by the eddy current testing detector 13 and the voltage regulator 12, and a change of the eddy current induced in the heat exchanger tube 1 is detected by the detection sensors 8A to 8D. Then, the computer 14 performs the steps of: obtaining detection signals from the detection sensors 8A to 8D through the eddy current testing detector 13; creating first detection data associated with positions of the detection sensors 8A to 8D based on the detection signals; storing the created first detection data in the storage device, and displaying the data on the monitor 15. The operator views the first detection data displayed on the monitor 15, and checks the magnitude of noise caused by the deformed portion of the heat exchanger tube and the tube sheet.

Subsequently, the eddy current testing sensor 5 is returned to the inspection start position in the same heat exchanger tube (for the simulation test). At the same time, the operator inputs and sets a second voltage pattern through the computer 14 and then re-inspects the heat exchanger tube with the same procedures as above. As a result, the computer 14 creates second detection data, stores the created second detection data in the storage device, and displays the data on the monitor 15. The operator views the second detection data displayed on the monitor 15, and confirms the magnitude of noise caused by the deformed portion of the heat exchanger tube and the tube sheet. Then, the operator displays the first and second detection data on the monitor 15. At the same time, the operator compares the magnitudes of noise to determine which of the first and second voltage patterns is desirable. For example, if the operator determines that neither the first nor second voltage pattern is desirable, the operator inputs and sets a third voltage pattern and then re-inspects the heat exchanger tube with the same procedures as above. Then, the operator confirms the magnitude of noise in the third voltage pattern, and determines whether or not the third voltage pattern is desirable. On the other hand, if the operator determines that either of the first and second voltage patterns is desirable, the operator inputs and sets the desirable voltage pattern through the computer 14, and starts inspection of the heat exchanger tube 1 (actual equipment) to be subjected to inspection.

With the present embodiment, as mentioned above, the amplitudes of voltages applied to the excitation coils 7A to 7D are differentiated from each other by the voltage regulator 12 so as to reduce detection noise caused by the deformed portion 1c of the heat exchanger tube 1 and the tube sheet 2. In this way, detection noise caused by the difference in positional accuracy of the detection sensors 8A to 8D at each channel or in liftoff of the excitation coils 7A to 7D can be reduced resulting in an improved SN ratio. Therefore, the detection accuracy of defects such as the circumferential crack E can be improved.

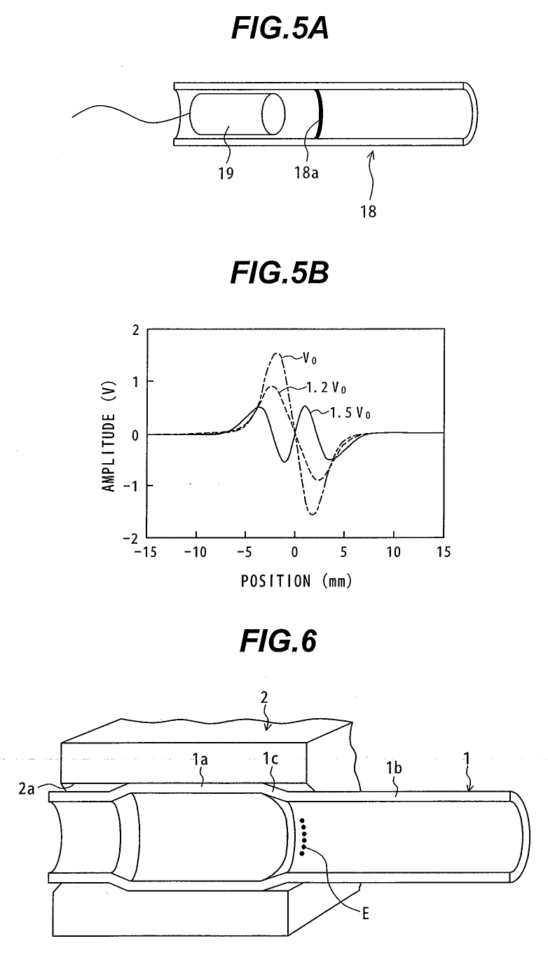

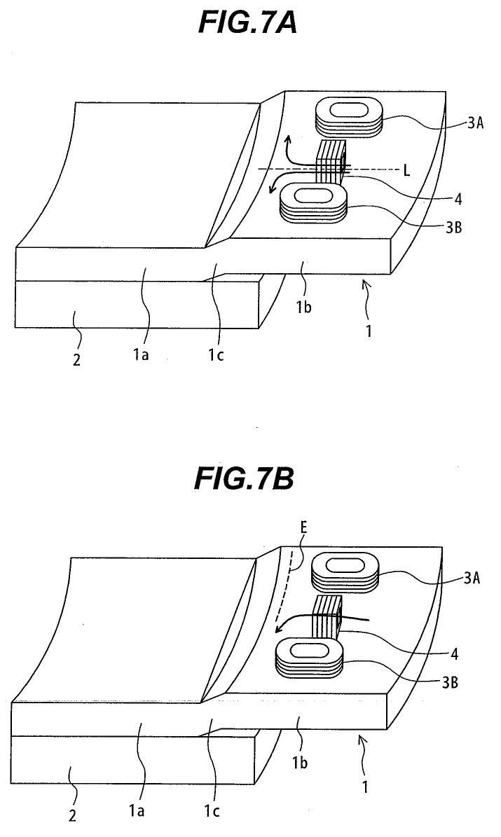

Further, the inventors of the present invention performed numerical calculation using a calculation model shown in FIG. 5A in order to confirm the effects of the above-mentioned present embodiment. A cylindrical tube made of stainless steel (SUS316) having an outer diameter of 15.9 mm and a radial thickness of 2.3 mm is used as a simulated heat exchanger tube 18 in this calculation model. A deformed portion 18a is provided over the entire inner circumferential surface of an area having an axial length of about 0.2 mm. An eddy current testing sensor 19 has the same structure as the eddy current testing sensor 5. With a pair of excitation coils of each channel, one coil has a liftoff of 0.8 mm and the other a liftoff of 0.9 mm. Numerical calculation was performed by fixing the voltage applied to one excitation coil (in other words, an excitation coil having a smaller liftoff) to V₀, and changing the voltage applied to the other excitation coil (in other words, an excitation coil having a larger liftoff) to Vo, 1.2Vo, and 1.5Vo. As a result, detection data as shown in FIG. 5B was obtained. Referring to FIG. 5B, the horizontal axis represents the axial position of the detection sensor in the simulated heat exchanger tube 18 (zero corresponds to the position of the deformed portion 18a of the simulated heat exchanger tube 18), and the vertical axis the amplitude of a detection signal. As shown in the result, detection noise in a case where voltages applied to the pair of excitation coils of each channel are differentiated (1.2Vo and 1.5Vo) is lower than detection noise in a case where the same voltage (Vo) is applied thereto.

With the above-mentioned embodiment, the eddy current testing sensor 5 is configured such that the excitation coils 7A to 7D and the detection coils 8A to 8D are circumferentially disposed at equal intervals on the main unit case 6, and moved only in the axial direction of the heat exchanger tube 1 by the cable winder 10, but not limited thereto. Specifically, for example, it is also possible to circumferentially and locally dispose the excitation coils and detection coil on the main unit case and, in this case, it is preferable to rotate the eddy current testing sensor in the circumferential direction of the heat exchanger tube. Also with such a modification, the same effects as above can be obtained.

With the above-mentioned embodiment, the heat exchanger tube 1 of a heat exchanger is subjected to inspection, but the embodiment is not limited to such a case. For example, it is also possible to apply the present embodiment to a case where a tube intended for a different purpose is subjected to inspection with the objective of reducing detection noise caused by a support member or the like present over the entire outer circumferential surface of the tube. Also in such a case, the same effects as above can be obtained.

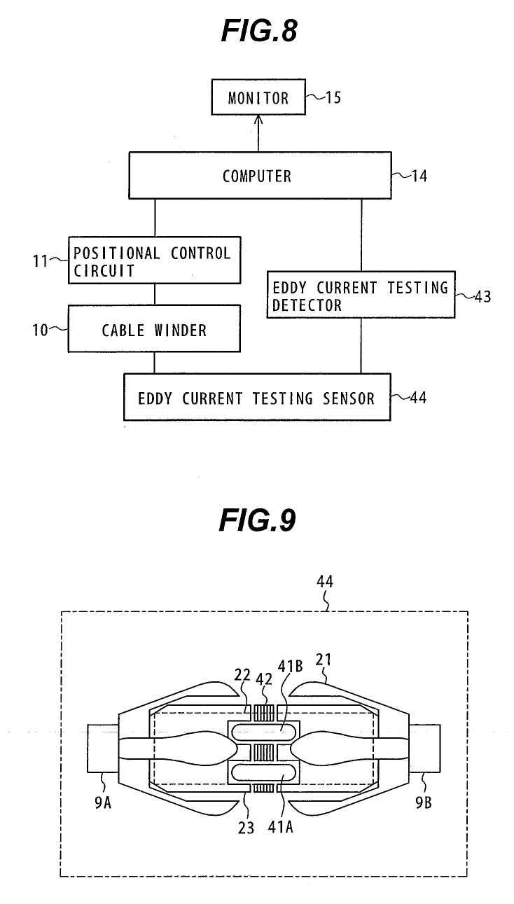

An embodiment of a second aspect of the present invention will be explained below with reference to FIGS. 8 to 17.

Various types of heat exchangers are installed in a power plant. In these heat exchangers, hundreds of heat exchanger tubes are regularly disposed. Although the size and shape of heat exchanger tubes differ from standard to standard, there is a heat exchanger tube having an outer diameter of 15.9 mm and a length of about 6 m, for example. In heat exchanger inspection, eddy current testing (ECT) is performed for each heat exchanger tube. Inspection procedures are as follows: An ECT sensor is once inserted deep inside a heat exchanger tube using an air gun. Then, while the cable is rewound to move the ECT sensor for scanning, a signal from the ECT sensor is measured at each position.

The ECT sensor, composed of excitation coils and detection coils, detects a change of an eddy current by the excitation coils as a voltage signal by means of the detection coils. Although a crack on the inner or outer surface of the heat exchanger tube can be detected, unnecessary signals (noise) are also observed in an actual equipment inspection. For example, a noise source located on the near side of the sensor is a change of shape caused by corrosion or adhesion on the inner surface of the heat exchanger tube or expansion of the tube, and a noise source located on the far side of the sensor is a support plate or tube sheet installed on the outer circumference of the tube.

As a method for detecting an outer surface crack when there is corrosion on the inner surface of the heat exchanger tube, JP-A-58-17354 discloses the multiple frequency method which performs differential processing of measured waveforms at two different excitation frequencies to restrain noise.

However, the technique described in JP-A-58-17354 is effective only for one noise source. At a portion like a tube expansion of the heat exchanger tube where there are two different noise sources, i.e., near-side noise (tube expansion noise) and far-side noise (tube sheet noise), the technique cannot reduce noise from either one noise source and therefore cannot detect a crack signal of the heat exchanger tube.

An object of an embodiment of the second aspect of the present invention, in a case where there are noise sources on the near and far sides of the sensor and intermediate positions therebetween are subjected to inspection, such as inspection of the tube expansion of the heat exchanger tube, is to reduce the influence by the near- and far-side noise sources and detect a crack signal.

First of all, the configuration and operation of an eddy current testing system using an eddy current testing apparatus according to the present embodiment will be explained below with reference to FIG. 8.

FIG. 8 is a block diagram showing the configuration of the eddy current testing system using the eddy current testing apparatus according to the present embodiment.

The eddy current testing system can be roughly divided into two systems: a positional control-and-drive system and a flaw detection control system of the eddy current testing sensor 44. The positional control-and-drive system of the eddy current testing sensor 44 controls the cable winder 10 provided with the eddy current testing sensor 44 through the positional control circuit 11 under the control of the computer 14. The eddy current testing sensor 44 is inserted into the heat exchanger tube with an air gun, then the cable is rewound with the cable winder 10. Here, the cable winder 10, the positional control circuit 11, and the computer 14 are ones that have been conventionally used.

With the flaw detection control system of the eddy current testing sensor 44, an eddy current testing detector 43 is electrically connected with the eddy current testing sensor 44 under the control of the computer 14. The states of the eddy current testing detector 44 and the above-mentioned control systems are monitored with the monitor 15, and can be changed and operated.

Electrical and mechanical connections of the positional control-and-drive system will be explained below. The eddy current testing sensor 44 is connected with the cable winder 10 through a cable. The cable winder 10 is electrically connected with the positional control circuit 11 which is connected with the computer 14 which is connected with the monitor 15. With the flaw detection control system, external input and output terminals of the eddy current testing sensor 44 are connected with the eddy current testing detector 43 which is connected with the computer 14.

The operation of the eddy current testing system is now explained. All control operations are monitored with the monitor 15, and settings are changed through the computer 14. Setup information (displacement, movement speed, etc.) in the computer 14 is transmitted to the positional control circuit 11. Electric power is sent to the cable winder 10 based on the information, and the cable winder 10 moves the eddy current testing sensor 44 to a target position. With the flaw detection control system, the setup information (transmit frequency, voltage, etc.) on the computer 14 is transmitted to the eddy current testing detector 43. An AC voltage of setup frequency is applied from the eddy current testing detector 43 to the input side of the excitation coils 41A and 41B of the eddy current testing sensor 44. The signal (induction) voltage on the output side of the detection coil 42 of the eddy current testing sensor 44 is sent to the eddy current testing detector 43. In the eddy current testing detector 43, the signal voltage is converted to an ECT signal having an in-phase X component and an out-of-phase Y component with respect to the excitation voltage. The ECT signal is transmitted to the computer 14 and observed with the monitor 15.

The configuration and operation of the eddy current testing sensor 44 used for the eddy current testing apparatus according to the present embodiment will be explained below with reference to FIGS. 9 to 11.

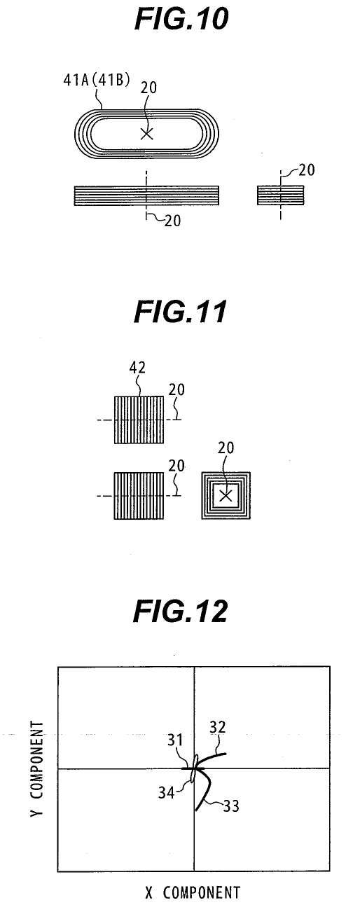

FIG. 9 is a plane view showing the configuration of the eddy current testing sensor used for the eddy current testing apparatus according to the present embodiment. FIG. 10 is a three-plane view showing the configuration of an excitation coil of the eddy current testing sensor used for the eddy current testing apparatus according to the present embodiment. FIG. 11 is a three-plane view showing the configuration of a detection coil of the eddy current testing sensor used for the eddy current testing apparatus according to the present embodiment.

As shown in FIG. 9, the eddy current testing sensor 44 having, for example, four channels, each composed of a combination of two excitation coils 41A and 41B and one detection coil 42. As shown in FIG. 10, each of the excitation coils 41A and 41B has the same configuration, that is, each formed by 200 windings of a lead wire having a diameter of 0.05 in racetrack shape. Reference numeral 20 of FIG. 10 denotes a coil axis. The curvature radius of the semicircle arc is 1 mm, and the length of the straight line is 4 mm. The two excitation coils 41A and 41B are disposed such that straight line portions thereof are opposed to each other at a distance of 8 mm from the center of each coil. The detection coil 42 is disposed at a central point between the excitation coils 41A and 41B. As shown in FIG. 11, the detection coil 42 is formed by 400 windings of a lead wire having a diameter of 0.04 in rectangular shape.

Here, the eddy current testing sensor composed of two excitation coils and one detection coil was previously proposed in JP-A-2007-263946 by the inventors of the present invention. As described in JP-A-2007-263946, the inventors propose a method for reducing noise of a tube expansion of heat exchanger tubes using the sensor including the excitation coils for generating an axial eddy current and the detection coil for detecting only the circumferential eddy current component. This sensor detects an edge of a local crack while restraining noise caused by the tube expansion (deformed portion) existing over the entire circumference of the tube and the tube sheet.

However, with the technique described in JP-A-2007-1263946, noise occurs if the coil arrangement becomes asymmetrical with respect to the tube expansion or tube sheet. For example, there may be a case where the distances (liftoffs) of the two excitation coils from the inner surface of the tube are different from each other depending on the sensor position in the tube, or a case where coil arrangement positions are shifted in the sensor. If the sensor position cannot be controlled with sufficient accuracy in actual equipment inspection, there may be a case where tube expansion noise and tube sheet noise cannot sufficiently be restrained.

In order to solve such a problem, with the present embodiment, the excitation coils 41A and 41B and the detection coil 42 are disposed on a coil seat 22 made of resin, and the coil arrangement is fixed by a coil retainer 23. Such a guide mechanism reduces an error of coil arrangement position inside the eddy current testing sensor 44.

Further, the eddy current testing sensor 44 installs a central axis adjustment mechanism 21 so that the eddy current testing sensor 44 is located at the center in the tube. The end of the excitation coils 41A and 41B and the detection coil 44 is directly connected with the lead wire in a cable 9A, resulting in electrical connection with the eddy current testing detector 43.

Further, another eddy current testing sensor having the same configuration as the eddy current testing sensor 44 is connected to a cable 9B. This eddy current testing sensor is connected with a lead wire inside the cable 9B and also electrically connected with the eddy current testing detector 43 through a lead wire inside the cable 9A. With an example shown in FIG. 9, there is a dead zone at a central position between the excitation coils 41A and 41B. Therefore, with another eddy current testing sensor connected to the cable 9B, the excitation coils are disposed such that the excitation coils shown in FIG. 9 are rotated by 22.5 degrees with respect to the central axis.

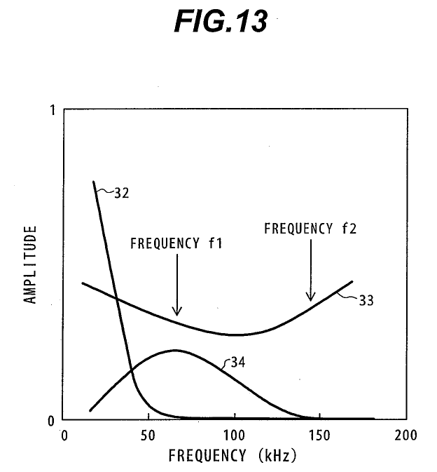

Signals and noise observed during inspection of the tube expansion of the heat exchanger tube by the eddy current testing apparatus according to the present embodiment will be explained below with reference to FIGS. 12 and 13.

FIGS. 12 and 13 are diagrams showing signals and noise observed during inspection of the tube expansion of the heat exchanger tube by the eddy current testing apparatus according to the present embodiment.

FIG. 12 shows Lissajous waveforms of a signal 34 and noise 31, 32, and 33. Lissajous waveforms are obtained with an in-phase X component and an out-of-phase Y component of a detection signal detected by the eddy current testing sensor 44, with respect to a reference signal of the eddy current testing detector 43.

Noise includes scanning noise 31, tube sheet noise 32, and tube expansion noise 33. Here, the scanning noise 31 occurs if the distance between the inner surface of the tube and the eddy current testing sensor slightly changes when the eddy current testing sensor 44 is moved inside the tube for scanning.

Referring to FIG. 12, the scanning noise 31 is displayed so that it is contained in the X component. The signal 34 is produced on the assumption of a crack having a depth of 20% of the tube radial thickness from the outer surface of the heat exchanger tube. In this case, the signal 34 is contained in the Y component and a waveform of the Y component is used to determine whether or not a crack is present. The tube sheet noise 32 and the tube expansion noise 33 are also contained in the Y component.

FIG. 13 shows frequency characteristics of the tube sheet noise 32, the tube expansion noise 33, and the signal 34 using the difference between the maximum and minimum values as the amplitude of the Y component of respective Lissajous waveform shown in FIG. 12. The frequency characteristics shown in FIG. 13 are obtained by the eddy current testing sensor 44 shown in FIG. 9. However, at the time of the application of the invention described in JP-A-2007-263946, attention was not paid to those frequency characteristics.

As shown in FIG. 13, the tube sheet noise 32 is on the far side of the eddy current testing sensor 44 and therefore can be asymptotically attenuated to zero amplitude as the excitation frequency increases. Here, with a low accuracy in arrangement of the excitation coils 41A and 41B and the detection coil 42, the tube sheet noise 32 is not attenuated to zero amplitude and therefore the accuracy in arrangement by the coil seat 22 and the coil retainer 23 can be obtained. On the other hand, the crack signal 34 once increases to reach a maximum value and then asymptotically decreases to zero amplitude.

Here, if the far-side noise is decreased to a negligible level at a frequency fa and a crack signal exists at a frequency fb (for example, in the case of the maximum value), a common sensor as described in JP-A-58-17354 satisfies fa>fb.

On the other hand, according to a sensor structure as described in JP-A-2007-263946 or FIG. 9, a condition fa<fb is satisfied. That is, under the condition fa<fb, processing can come down to the multi-frequency method which detects a crack signal for the near-side noise source.

Therefore, with the present embodiment, there are noise sources on the near and far sides of the sensor, intermediate positions therebetween are subjected to inspection, and the multi-frequency method is applied on the premise of a sensor that satisfies the condition fa<fb as frequency characteristics.

The present embodiment performs the steps of: measuring a waveform by an excitation frequency f1 at which the tube sheet noise 32 of the far-side noise source is attenuated to an ignorable level, and a waveform by an excitation frequency f2 (>f1) higher than the frequency f1; adjusting the phase and gain of a detection signal with the frequency f2 and performing differential processing of the two waveforms, frequencies f1 and f2, so as to cancel out the influence by the tube expansion noise 33 from the near-side noise source.

Here, the frequency f1 is a frequency around which the amplitude of the signal 34 reaches a maximum value. In the example shown in FIG. 13, the frequency f1 is 70 kHz for example. The frequency f2 is a frequency around which the amplitude of the signal 34 reaches a minimum value. In the example shown in FIG. 13, the frequency f2 is 150 kHz for example. If the frequencies f1 and f2 are selected in this way and then differential processing performed, the sensitivity to the signal 34 can be increased.

On the other hand, as shown in FIG. 13, the amplitude of the tube expansion noise 33 at the frequency f1 is different from the amplitude of the tube expansion noise 33 at the frequency f2. Further, although not shown, the phase of the tube expansion noise 33 at the frequency f1 is different from the phase of the tube expansion noise 33 at the frequency f2. Then, if a gain G and a phase θ of the detection signal for the frequency f2 are adjusted so that the tube expansion noise 33 at the frequency f1 agrees with the tube expansion noise 33 at the frequency f2 and then differential processing is performed, the tube expansion noise 33 can be eliminated.

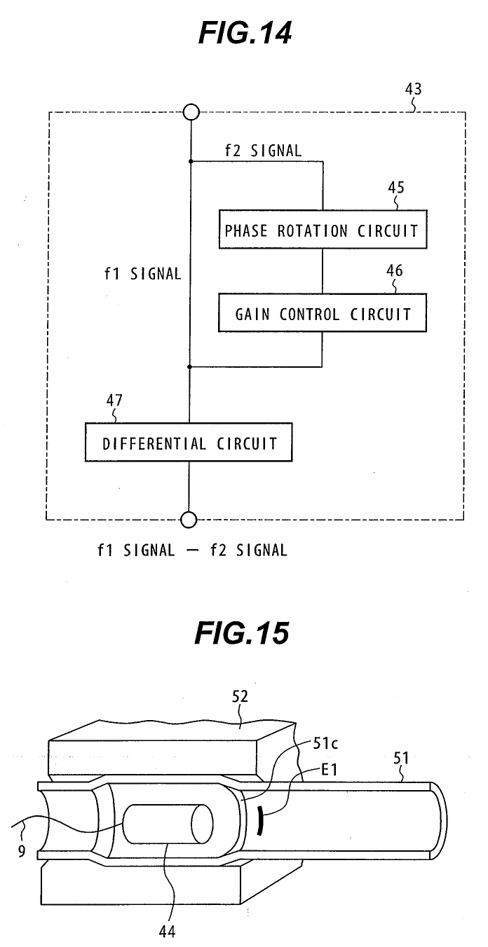

The internal processing of the eddy current testing detector 43 of the eddy current testing apparatus according to the present embodiment will be explained below with reference to FIG. 14.

FIG. 14 is a block diagram explaining the internal processing of the eddy current testing detector of the eddy current testing apparatus according to the present embodiment.

The eddy current testing detector 43 handles ECT signals having the excitation frequencies f1 and f2 (f1 and f2 signals). The f1 signal is directly input to a differential circuit 47, and the f2 signal to the differential circuit 47 through a phase rotation circuit 45 and a gain control circuit 46. The waveform of the f2 signal is adjusted by the phase rotation circuit 45 and the gain control circuit 46 so as to eliminate the tube expansion noise of the f1 signal. The output from the differential circuit 47 is only the signal 34, and is observed with the monitor 15

Prior to phase and gain adjustment, a heat exchanger tube with no crack is prepared for a simulation test. This tube for the simulation test is irradiated with excitation signals having frequencies f1 and f2 by the eddy current testing sensor 44 to detect ECT signals by the eddy current testing sensor 44.

The detected ECT signals are displayed on the monitor 15 through the eddy current testing detector 43 and the computer 14. Then, the gain control circuit 46 shown in FIG. 14 controls the gain of the f2 signal so that the signal displayed on the monitor 15 reaches a minimum value. After the signal reaches a minimum value, the phase rotation circuit 45 shown in FIG. 14 controls the phase of the f2 signal to set the signal to zero. This completes gain and phase adjustment thus allowing elimination of the tube expansion noise 33.

Measurement results obtained by the eddy current testing apparatus according to the present embodiment will be explained below with reference to FIGS. 15 to 17.

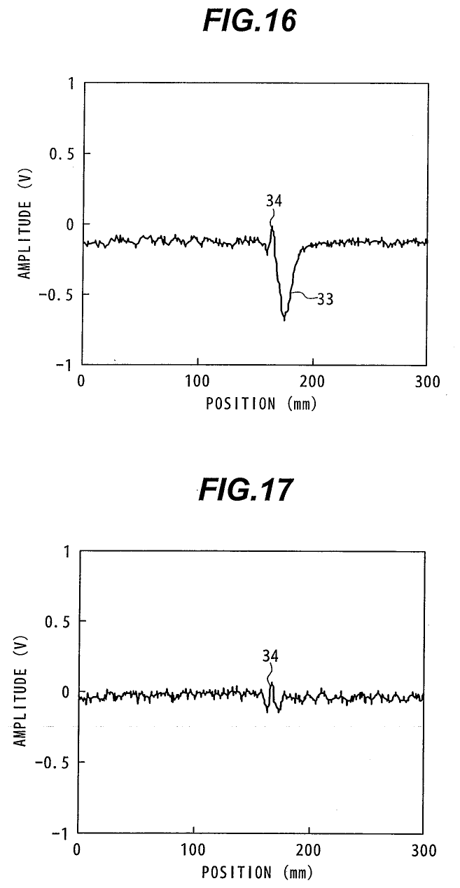

FIG. 15 is a cross-sectional perspective view showing the structure of the simulated test piece used for a test of the eddy current testing apparatus according to the present embodiment. FIG. 16 is a diagram explaining a measurement result obtained by a conventional eddy current testing apparatus. FIG. 17 is a diagram explaining a measurement result obtained by the eddy current testing apparatus according to the present embodiment.

FIG. 15 shows a heat exchanger tube 51 (simulated test piece) prepared for measurement by the eddy current testing apparatus according to the present embodiment. There is a simulated circumferential crack E1 from the outer surface on a base material SUS316 having an outer diameter of 15.9 mm and a radial thickness of 2.3 mm. The depth of the crack E1 is 0.46 mm. A tube expansion (deformed portion) 51c is formed at a part of the heat exchanger tube 51, and the tube sheet 52 made of magnetic material is closely in contact with the outer circumference of the heat exchanger tube 51.

The eddy current testing sensor 44 is inserted into the heat exchanger tube 51, and the cable is rewound with the cable winder to move the eddy current testing sensor 44 for scanning to observe the ECT signals.

FIG. 16 shows an ECT signal according to the conventional method based on only one frequency (f=70 kHz) using a sensor disclosed in JP-A-2007-263946. Referring to FIG. 16, the noise 33 from the tube expansion 51c is observed as a large noise in addition to the signal 34 from the circumferential crack E1.

FIG. 17 shows a measurement result obtained by the eddy current testing apparatus according to the present embodiment. FIG. 17 shows a waveform after differential processing of ECT signals (f1=70 kHz and f2=150 kHz). Referring to FIG. 17, the tube expansion noise 33 detected in FIG. 16 is restrained, and the local circumferential crack E1 is detected as the signal 34. Noise from the tube expansion is not detected.

A simultaneous excitation technique of the present embodiment is likely to be used in inspection of a tube expansion of heat exchanger tubes of a heat exchanger installed in a nuclear plant, which has been conventionally considered to be difficult because of noise or other problems with a conventional multi-coil probe.

As explained above, even in a case where there are noise sources on the near and far sides of the sensor and intermediate positions therebetween are subjected to inspection, such as inspection of a tube expansion of heat exchanger tubes, the present embodiment can restrain the influence by the near- and far-side noise sources and detect a crack signal.

What is claimed is:

1. An eddy current testing method using an eddy current testing sensor comprising:
a pair of excitation coils disposed such that each of their axial directions becomes approximately perpendicular to the inspection surface of a subject and such that the pair of excitation coils are spaced from each other in the coil radial direction, the pair of excitation coils adapted to induce an eddy current in the subject; and
a detection coil disposed between the pair of excitation coils so that its axial direction becomes approximately in parallel with the inspection surface of the subject and approximately perpendicular to a straight line connecting the centers of the excitation coils to detect a change of the eddy current induced in the subject;
wherein voltages having different amplitudes are applied to the pair of excitation coils so as to reduce detection noise of the detection coil.

2. An eddy current testing apparatus including an eddy current testing sensor comprising:
a pair of excitation coils disposed such that each of their axial directions becomes approximately perpendicular to the inspection surface of a subject and such that the pair of excitation coils are spaced from each other in the coil radial direction, the pair of excitation coils adapted to induce an eddy current in the subject; and
a detection coil disposed between the pair of excitation coils so that its axial direction becomes approximately in parallel with the inspection surface of the subject and approximately perpendicular to a straight line connecting the centers of the excitation coils to detect a change of the eddy current induced in the subject;
wherein the eddy current testing apparatus includes excitation voltage control means for differentiating amplitudes of voltages applied to the pair of excitation coils so as to reduce detection noise of the detection coil.

3. The eddy current testing apparatus according to claim 2, wherein:
the eddy current testing apparatus includes input setup means for inputting and setting amplitudes of voltages to be applied to the pair of excitation coils; and
the excitation voltage control means controls the amplitudes of voltages applied to the pair of excitation coils connected in parallel according to input setup by the input setup means.

4. An eddy current testing method comprising the steps of:
inserting an eddy current testing sensor into a tube;
applying excitation voltages to excitation coils of the eddy current testing sensor; and
detecting a crack of the tube based on an induction voltage detected from a detection coil of the eddy current testing sensor;
wherein there are noise sources on the near and far sides of the position of the eddy current testing sensor, and intermediate positions therebetween are subjected to inspection;
wherein the eddy current testing sensor has a cylindrical shape, at least two excitation coils and one detection coil are disposed on its side surface, and the winding direction of the detection coil agrees with the circumferential direction of the eddy current testing sensor;
wherein a first excitation frequency f1, at which the far-side noise source is reduced to a negligible amplitude, and a second excitation frequency f2, which is higher than the first excitation frequency f1, are applied to the eddy current testing sensor; and
wherein the phase and gain of a measurement waveform with the second excitation frequency f2 are adjusted and then a differential waveform of the first and second excitation frequencies f1 and f2 is observed based on the induction voltage detected by the detection coil so as to cancel out the influence by the near-side noise source.

5. The eddy current testing method according to claim 4, wherein:
the first excitation frequency f1 is set such that the induction voltage detected in relation to the crack on the tube by the detection coil reaches a maximum value at around the first excitation frequency f1; and
the second excitation frequency f2 is set such that the induction voltage detected in relation to the crack on the tube by the detection coil reaches a minimum value at around the second excitation frequency f2.

6. An eddy current testing apparatus which performs the steps of: inserting an eddy current testing sensor into a tube; applying excitation voltages to excitation coils of the eddy current testing sensor; and detecting a crack of the tube based on an induction voltage detected from a detection coil of the eddy current testing sensor;
wherein the eddy current testing sensor has a cylindrical shape, at least two excitation coils and one detection coil are disposed on its side surface, and the winding direction of the detection coil agrees with the circumferential direction of the eddy current testing sensor; and
wherein the eddy current testing apparatus includes an eddy current testing detector which performs the steps of: applying a first excitation frequency f1, at which the far-side noise source is reduced to a negligible amplitude, and a second excitation frequency f2, which is higher than the first excitation frequency f1, are applied to the eddy current testing sensor; adjusting the phase and gain of a measurement waveform with the second excitation frequency f2 and calculating a difference between the first and second excitation frequencies f1 and f2 based on the induction voltage detected by the detection coil so as to cancel out the influence by the near-side noise source.

7. The eddy current testing apparatus according to claim 6, wherein:
the eddy current testing sensor comprises:
a seat for fixing the radial position of the excitation coils and the detection coil;
a retaining mechanism for adjusting the axial and circumferential positions of the excitation coils and the detection coil; and
a central axis adjustment mechanism for adjusting the position of the eddy current testing sensor with respect to the inner surface of the tube;
wherein the excitation coils and the detection coil are guided.
